(19) United States
(12) Patent Application Publication
(10) Pub. No.: US 2026/0308495 A1
(43) Pub. Date: Oct. 8, 2026

(54) ALCOHOL-CONTAINING COMPOSITION

(71) Applicant: SUNTORY HOLDINGS LIMITED, Osaka-shi, Osaka (JP)

(72) Inventors: Mayu Miyajima, Kanagawa (JP); Masahide Uemura, Kanagawa (JP); Shinya Ouchi, Kanagawa (JP)

(73) Assignee: SUNTORY HOLDINGS LIMITED, Osaka-shi, Osaka (JP)

(21) Appl. No.: 19/482,408

(22) PCT Filed: May 22, 2024
(86) PCT No.: PCT/JP2024/018782

§ 371 Date: Nov. 7, 2025

(30) Foreign Application Priority Data
May 26, 2023 (JP) 2023-087103

(51) Int. Cl. C12G 3/06

(52) U.S. Cl. CPC C12G 3/06

(57) ABSTRACT

The present invention addresses the problem of providing an alcohol-containing composition having a reduced stimulative sensation of alcohol. This alcohol-containing composition has linalool and/or geraniol blended therein, and has cis-3-hexen-1-ol blended therein. The alcohol-containing composition can alleviate sensation of irritation of alcohol. By blending linalool and/or geraniol and cis-3-hexen-1-ol, the sensation of irritation of the alcohol enhanced in the alcohol-containing composition having a low degree of sweetness can also be sufficiently reduced.

### TECHNICAL FIELD

The present invention relates to an alcohol-containing composition and the like. More specifically, the present invention relates to a composition having reduced sensation of irritation of alcohol, a method for producing the composition, and the like.

### BACKGROUND ART

In recent years, consumption of alcoholic beverages has been decreasing particularly among young people. As a cause of the decrease, it is pointed out that consumers' preference for alcoholic beverages is diversified, and drinking style is greatly changing. In order to respond to such a change, each alcoholic beverage manufacturer has intensively developed various new alcoholic beverage products. In developing such new products, various problems that have not been recognized in the past have become apparent.

For example, in alcoholic beverages, while a light flavor of alcohol is preferred, sensation of irritation of alcohol may be pointed out as a disadvantage. In the prior art, a method using a physical device and a flavor-improving agent is known as a means for reducing such sensation of irritation of alcohol.

As a method using the physical device, specifically, a method of ultrasonically treating an alcoholic beverage (Patent Literature 1), a method of bringing an alcoholic beverage into contact with a ceramic (Patent Literature 2), a method of emitting a magnetic field line at the time of producing an alcoholic beverage (Patent Literature 3), a method of stirring an alcoholic beverage with ultrasonic vibration (Patent Literature 4), a method of bringing an alcoholic beverage into contact with a semiconductor material (Patent Literature 5), and the like are known. However, these methods have disadvantages such as insufficient improvement of sensation of irritation of alcohol of the alcoholic beverage, and requirement of a large-scale device.

As a method for masking sensation of irritation of alcohol, a method using a masking agent such as an aliphatic ester (Patent Literature 6) is known; and however, the method has disadvantages that the masking agent can be used only for a specific alcoholic beverage, and taste and color of the masking agent itself easily affects flavor and color tone of the alcoholic beverage.

### CITATION LIST

### Patent Literature

Patent Literature 1: JP S54-119098 A
Patent Literature 2: JP S63-12273 A
Patent Literature 3: JP H6-30758 A
Patent Literature 4: JP H11-9257 A
Patent Literature 5: JP 2000-224979 A
Patent Literature 6: JP H8-187277 A

### SUMMARY OF INVENTION

### Technical Problem

In order to cope with diversification of consumers' preference for alcoholic beverages, various alcohol-containing compositions are manufactured and sold. However, the problem of the sensation of irritation of alcohol described above has not necessarily been sufficiently solved. In addition, from the viewpoint of enjoying alcoholic beverages together with meals, demand for a tea-based alcoholic beverage having a low degree of sweetness is increasing; and however, when the degree of sweetness is reduced, there is a problem that the sensation of irritation derived from alcohol in an alcohol-containing composition is further enhanced. In view of such circumstances, an object of the present invention is to provide an alcohol-containing composition having a reduced sensation of irritation of alcohol.

### Solution to Problem

The present inventors have developed an alcohol-containing composition that satisfies requirements of consumers while alleviating sensation of irritation of alcohol. As a result, the present inventors have found that by blending linalool and/or geraniol and cis-3-hexen-1-ol, the sensation of irritation of the alcohol in the alcohol-containing composition can be reduced. In addition, the present inventors have also found that by blending linalool and/or geraniol and cis-3-hexen-1-ol, the sensation of irritation of the alcohol enhanced in the alcohol-containing composition having a low degree of sweetness can also be sufficiently reduced, and thus have completed the present invention.

That is, the present invention includes, but is not limited to, the invention of the following aspects.

(1) A composition including:
linalool and/or geraniol;
cis-3-hexen-1-ol; and
an alcohol.

(2) The composition according to (1), wherein a degree of sweetness per 1.0 v/v % alcohol by volume is 0.18 or less.

(3) The composition according to (1) or (2), wherein a content of cis-3-hexen-1-ol per 1.0 v/v % alcohol by volume is 0.05 ppb or more.

(4) The composition according to any one of (1) to (3), wherein a content of linalool per 1.0 v/v % alcohol by volume is 0.02 ppb or more.

(5) The composition according to any one of (1) to (4), wherein a content of geraniol per 1.0 v/v % alcohol by volume is 0.05 ppb or more.

(6) The composition according to any one of (1) to (5), wherein the alcohol by volume is from 1 to 55 v/v %.

(7) The composition according to any one of (1) to (6), further including tannin, wherein a content of the tannin per 1.0 v/v % alcohol by volume is 200 ppm or less.

(8) The composition according to any one of (1) to (7), comprising linalool, geraniol and/or cis-3-hexen-1-ol derived from a Theaceae plant.

(9) The composition according to (8), wherein the Theaceae plant is Camellia sinensis.

(10) The composition according to any one of (1) to (9), including linalool and cis-3-hexen-1-ol derived from green tea.

(11) The composition according to any one of (1) to (10), including green tea distilled liquor.

(12) The composition according to any one of (1) to (11), wherein the composition contains no carbon dioxide gas is not contained.

(13) The composition according to any one of (1) to (12), wherein a total amount of an extract content is 50.0 g/100 ml or less.

(14) The composition according to any of (1) to (13), wherein the composition is a beverage.

(15) The composition according to (14), wherein the composition is a packaged beverage.

(16) The composition according to (14) or (15), wherein the composition is diluted and then consumed.

(17) A method for producing a composition, the method including:
(i) blending linalool and/or geraniol;
(ii) blending cis-3-hexen-1-ol; and
(iii) blending an alcohol.

(18) A method for reducing bitterness of an alcohol in an alcohol-containing composition, the method including:
(i) blending linalool and/or geraniol;
(ii) blending cis-3-hexen-1-ol; and
(iii) blending an alcohol.

### Advantageous Effects of Invention

According to the present invention, it is possible to provide an alcohol-containing composition which has a reduced sensation of irritation of alcohol and is quaffable. Such a composition has excellent quality to satisfy consumers' preference. In the present invention, the “sensation of irritation of alcohol” refers to the sensation of irritation of alcohol at the time of drinking and opening.

### DESCRIPTION OF EMBODIMENTS

### 1. Composition

In one aspect, the present invention is a composition containing linalool and/or geraniol, cis-3-hexen-1-ol, and an alcohol.

The present invention relates to an alcohol-containing composition. Also, in one aspect, the present invention relates to a tea-based alcohol-containing composition having a tea flavor. Green tea, oolong tea, or the like is used as a part of a raw material of the tea-based alcohol-containing composition. Examples of the tea-based alcohol-containing composition having the tea flavor, which uses green tea, oolong tea, or the like as a part of the raw material, include an infused liquor obtained by infusing green tea, oolong tea, or the like in an alcohol-containing liquid, and a distilled liquor obtained by bringing green tea, oolong tea, or the like into contact with an alcohol-containing liquid and then distilling the resultant liquid, in the case of blending an extraction liquid of green tea, oolong tea, or the like, or in the case of adding green tea, oolong tea, or the like itself and/or a powdery product thereof. The alcohol used in the composition of the present invention is not particularly limited, and those usually used for alcoholic beverages such as distilled liquor, fruit liquor, and sake (Japanese sake) can be used; and however, for example, alcohol for brewage, spirits (neutral spirits, rum, vodka, gin, etc.), whiskey, brandy, Ko-rui shochu, Otsu-rui shochu, Ko Otsu mixed shochu, and the like can be used alone or in combination. Among them, it is preferable to use, as a part or all of undiluted alcohol distillate, an undiluted alcohol distillate obtained by distilling an alcohol-containing product such as Otsu-rui shochu using a pot still, and an undiluted alcohol distillate obtained by mixing a product obtained by distilling an alcohol-containing product such as Ko Otsu mixed shochu using the pot still with a product obtained by distilling an alcohol-containing product using a column still.

In the present invention, the alcohol refers to ethyl alcohol (ethanol) unless otherwise noted. In addition, the alcohol by volume refers to vol. % (v/v %) in a beverage. In the composition of the present invention, the alcohol by volume is not particularly limited as long as each of the contents of linalool, geraniol, cis-3-hexen-1-ol, and the like in the composition is within a predetermined range, and is typically from 1 to 55 v/v %. In an aspect, the upper limit value of the alcohol by volume in the composition of the present invention is 50 v/v %, 45 v/v %, 40 v/v %, 35 v/v %, or 30 v/v %, and the lower limit value is 1.0 v/v %, 1.5 v/v %, 2.0 v/v %, 2.5 v/v %, or 3 v/v %.

The composition of the present invention is a beverage in one aspect, and a low-concentration alcoholic beverage which is consumed as it is in one aspect. The upper limit value of the alcohol by volume of the low-concentration alcoholic beverage is 15 v/v %, 12 v/v %, 10 v/v %, or 8.0 v/v %, and the lower limit value is 1.5 v/v %, 2.0 v/v %, 2.5 v/v %, or 3.0 v/v % as described above.

The composition of the present invention is the beverage in one aspect, a high-concentration alcoholic beverage which is diluted as necessary and then consumed in one aspect, and an undiluted alcohol distillate included in an alcoholic beverage in one aspect. The lower limit value of the alcohol by volume of the high-concentration alcoholic beverage is 15 v/v %, 18 v/v %, 20 v/v %, or 22 v/v %, and the upper limit value is 55 v/v %, 50 v/v %, 45 v/v %, 40 v/v %, 35 v/v %, 30 v/v %, or 28 v/v %.

When the composition of the present invention is the high-concentration alcoholic beverage that is diluted as necessary and then consumed, a solvent for the dilution is not particularly limited, and for example, water, warm water, hot water, carbonated water, fruit juice, milk and a milk fermented composition, tea-based beverages such as green tea, oolong tea, and black tea, cola, ginger ale, and the like can be used.

When the composition of the present invention is the undiluted alcohol distillate included in the alcoholic beverage, the solvent for the dilution is not particularly limited, and for example, water, warm water, hot water, carbonated water, fruit juice, milk and a milk fermented composition, tea-based beverages such as green tea, oolong tea, and black tea, cola, ginger ale and the like can be used. A single type of the undiluted alcohol distillate may be used, or two or more types of the undiluted alcohol distillates may be used in combination. The type of the undiluted alcohol distillates to be combined is not particularly limited, and those usually used for alcoholic beverages such as distilled liquor, fruit liquor, and sake (Japanese sake) can be used; and however, for example, alcohol for brewage, spirits (neutral spirits, ram, vodka, gin, etc.), whiskey, brandy, Ko-rui shochu, Otsu-rui shochu, Ko Otsu mixed shochu, and the like can be used alone or in combination. Among them, it is preferable to use, as a part or all of undiluted alcohol distillate, an undiluted alcohol distillate obtained by distilling an alcohol-containing product such as Otsu-rui shochu using a pot still, and an undiluted alcohol distillate obtained by mixing a product obtained by distilling an alcohol-containing product such as Ko Otsu mixed shochu using the pot still with a product obtained by distilling an alcohol-containing product using a column still.

As a method for adjusting the alcohol content, any known method such as adjustment of an amount of an alcohol component to be added may be used.

In the present specification, the alcohol by volume of the alcoholic beverage can be measured by any known method and can be measured, for example, with a vibrating densimeter. Specifically, the alcohol by volume can be determined by preparing a sample from an alcoholic beverage by removing carbon dioxide gas using filtration or ultrasonication, distilling the prepared sample over direct heat, measuring the density of the resulting distillate at 15° C., and converting the density using “Table 2. Conversion Table of Alcohol Content, Density (15° C.), and Specific Gravity (15/15° C.)”, which is an attached table of the Official Analysis Method of the National Tax Agency in Japan (2007 National Tax Agency Order No. 6, revised: Jun. 22, 2007).

The composition of the present invention includes cis-3-hexen-1-ol, which is a type of unsaturated alcohol, also referred to as green leaf alcohol. Cis-3-hexen-1-ol is a colorless liquid at normal temperature, which has been discovered and named as an scent component of green tea. In the composition of the present invention, the content of cis-3-hexen-1-ol in the composition is not particularly limited as long as a predetermined effect can be obtained; and however, the lower limit value of the content of cis-3-hexen-1-ol in the composition per 1.0 v/v % alcohol by volume is preferably 0.05 ppb, 0.10 ppb, 0.20 ppb, 0.30 ppb, 0.50 ppb, 0.80 ppb, and 1.20 ppb, and more preferably 1.50 ppb, and the upper limit value of the content of cis-3-hexen-1-ol in the composition per 1.0 v/v % alcohol by volume is preferably 2,000 ppb, 1,500 ppb, 1,000 ppb, 800 ppb, 600 ppb, 400 ppb, and 300 ppb, and more preferably 200 ppb. Typically, in the composition of the present invention, the content range of cis-3-hexen-1-ol in the composition per 1.0 v/v % alcohol by volume is from 0.05 to 2,000 ppb, from 0.10 to 1,500 ppb, from 0.20 to 1,000 ppb, from 0.30 to 800 ppb, from 0.50 to 600 ppb, from 0.80 to 400 ppb, from 1.20 to 300 ppb, or from 1.50 to 200 ppb. When the content of cis-3-hexenol in the composition per 1.0 v/v % alcohol by volume is less than 0.05 ppb, the effect of reducing the sensation of irritation of alcohol in an alcoholic beverage having a low degree of sweetness tends to be reduced when the alcohol by volume is adjusted to from 2 to 20 v/v % for drinking, and on the other hand, when the content of cis-3-hexen-1-ol per of 1.0 v/v % alcohol by volume is more than 2,000 ppb, a blue scent peculiar to cis-3-hexen-1-ol is strongly felt.

In the present invention, the method for measuring the content of cis-3-hexen-1-ol is not particularly limited, and a known method can be appropriately selected and used. For example, it is preferable to measure the content using GC-MS.

The composition of the present invention includes linalool and/or geraniol. Linalool is a type of monoterpene alcohol represented by the molecular formula C₁₀H₁₈O, and it is known that linalool has a scent like lignin, lavender, or bergamot. Geraniol is a type of linear monoterpenoid represented by the chemical formula C₁₀H₁₇OH, and is known to be contained in essential oils such as rose oil, palmarosa oil, and citronella oil, and to have a rose-like scent.

In the composition of the present invention, the lower limit value of the content of linalool in the composition per 1.0 v/v % alcohol by volume is preferably 0.02 ppb, 0.05 ppb, 0.15 ppb, 0.30 ppb, 0.50 ppb, 0.80 ppb, 1.20 ppb, and more preferably 1.50 ppb. In one aspect, the upper limit value of the content of linalool in the composition per 1.0 v/v % alcohol by volume is preferably 2,000 ppb, 1,500 ppb, 1,000 ppb, 800 ppb, 600 ppb, 400 ppb, 300 ppb, and more preferably 200 ppb. Typically, in the composition of the present invention, the content range of linalool in the composition per 1.0 v/v % alcohol by volume is from 0.02 to 2,000 ppb, from 0.05 to 1,500 ppb, from 0.15 to 1,000 ppb, from 0.30 to 800 ppb, from 0.50 to 600 ppb, from 0.80 to 400 ppb, from 1.20 to 300 ppb, or from 1.50 to 200 ppb. When the content of linalool in the composition per 1.0 v/v % alcohol by volume is less than 0.02 ppb, the effect of reducing the sensation of irritation of alcohol in the alcohol-containing composition having a low degree of sweetness tends to be reduced at the time of drinking or opening, and on the other hand, when the content of linalool per 1.0 v/v % alcohol by volume is more than 2,000 ppb, the scent becomes strong, so that an artificial flavor is obtained, and it is felt that it is difficult to drink.

In the composition of the present invention, the lower limit value of the content of geraniol in the composition per 1.0 v/v % alcohol by volume is preferably 0.05 ppb, 0.10 ppb, 0.15 ppb, 0.20 ppb, 0.25 ppb, 0.30 ppb, and 0.35 ppb. In one aspect, the upper limit value of the content of geraniol in the composition per 1.0 v/v % alcohol by volume is preferably 2,000 ppb, 1,500 ppb, 1,000 ppb, 800 ppb, 600 ppb, 400 ppb, 300 ppb, and more preferably 200 ppb. Typically, in the composition of the present invention, the content range of geraniol in the composition per 1.0 v/v % alcohol by volume is from 0.05 to 2,000 ppb, from 0.10 to 1,500 ppb, from 0.15 to 1,000 ppb, from 0.20 to 800 ppb, from 0.20 to 600 ppb, from 0.25 to 400 ppb, from 0.30 to 300 ppb, or from 0.35 to 200 ppb. When the content of geraniol in the composition per 1.0 v/v % alcohol by volume is less than 0.05 ppb, the effect of reducing the sensation of irritation of alcohol in the alcohol-containing composition having a low degree of sweetness tends to be reduced at the time of drinking or opening, and on the other hand, when the content of geraniol per 1.0 v/v % alcohol by volume is more than 2,000 ppb, the scent becomes strong, so that an artificial flavor is obtained, and it is difficult to drink.

In the present invention, the method for measuring the content of linalool and geraniol is not particularly limited, and a known method can be appropriately selected and used. For example, the content is preferably measured using LC-MS or HPLC, and particularly preferably measured using HPLC.

The degree of sweetness of the composition of the present invention is low. Specifically, the degree of sweetness of the composition of the present invention per 1.0 v/v % alcohol by volume is 0.18 or less, preferably 0.15 or less, and more preferably 0.12 or less. The lower limit value of the degree of sweetness of the composition of the present invention per 1.0 v/v % alcohol by volume is not particularly limited, and may be any of 0.01, 0.02, 0.03, 0.04, 0.05, 0.06, 0.07, 0.08, 0.09, and 0.10, or more, or may be 0. When the degree of sweetness per 1.0 v/v % alcohol by volume is more than 0.18, it is difficult to feel the sensation of irritation of alcohol that remains after drinking, and therefore, the problem of the present invention does not occur.

In one aspect, the degree of sweetness of the composition of the present invention is 4.5 or less, preferably 4.0 or less, and more preferably 3.5 or less. The lower limit value of the composition of the present invention is not particularly limited, and may be 0.1, 0.2, 0.3, 0.4, 0.5, 0.6, 0.7, 0.8, 0.9, or 1.0, or more, or may be 0.

The term “degree of sweetness” in the present specification, refers to an indicator of sweetness of beverages in which the sweetness of a beverage containing 1 g of sucrose in 100 g of the beverage is defined as “1”. The degree of sweetness of the beverage is determined by converting the content of each sweet ingredient into an equivalent amount of sucrose based on the relative ratio of the sweetness of the sweet ingredient to a sweetness of sucrose of 1, and then totaling the sucrose equivalent sweetnesses of all sweet ingredients contained in the beverage (including sweet ingredients derived from fruit juice, extract, and the like). The relative ratios of the sweetnesses of various representative sweet ingredients to a sweetness of sucrose of 1 are listed in Table 1. For a sweet ingredient not listed in Table 1, the degree of sweetness presented by a manufacturer that manufactures or markets the sweet ingredient can be used, or the degree of sweetness can be determined by sensory evaluation.

TABLE 1

| Sweet ingredient | Degree of sweetness |
|---|---|
| Sucrose (cane sugar) | 1 |
| Glucose (grape sugar) | 0.6 |
| Fructose (fruit sugar) | 12 |
| Isomerized sugar (55% fructose) | 1 |
| Lactose (milk sugar) | 0.15 |
| Trehalose | 0.4 |
| D-psicose | 0.7 |
| Maltose | 0.4 |
| Sorbitol | 0.6 |
| Mannitol | 0.6 |
| Maltitol | 0.8 |
| Xylitol | 0.6 |
| Reduced palatinose | 0.45 |
| Erythritol | 0.8 |
| Lactitol | 0.8 |
| Hydrogenated starch hydrolysates | 0.1 |
| Stevia | 100 |
| Glycyrrhizin | 50 |
| Thaumatin | 2000 |
| Saccharin | 200 |
| Aspartame | 100 |
| Acesulfame potassium | 200 |
| Sucralose | 600 |
| Alitame | 2000 |
| Cyclamate | 30 |
| Dulcin | 200 |
| Neotame | 1000 |
| Neohesperidin | 1000 |
| Monellin | 25000 |
| Lysozyme | 20 |
| Maltooligosaccharides | 0.45 |

In the composition of the present invention, the degree of sweetness can be adjusted using a sweet ingredient. As the sweet ingredient, for example, any of the sweet ingredients listed in Table 1 can be used; and however, another sweet ingredient other than the sweet ingredients listed in Table 1 may be used. In the present invention, the sweet ingredient may be directly blended as a sweetener into the composition, or fruit juice or extract containing the sweet ingredient may be blended. Preferred examples of the sweet ingredient are fructose, isomerized sugars, glucose, sucrose, lactose, oligosaccharides (such as maltooligosaccharides), and sugar alcohols (such as erythritol and xylitol), and particularly preferred examples of the sweet ingredient are fructose and sucrose. In the composition of the present invention, it is preferable not to use a high-intensity sweetener in the beverage, because a clear-cut natural sweetness can be imparted to the beverage. The high-intensity sweetener used herein means an artificial or natural sweetener having the degree of sweetness ten times or more than that of sucrose, and examples of the high-intensity sweetener include sucralose, acesulfame potassium, aspartame, and stevia.

In one aspect, the type of the composition of the present invention is not particularly limited, and the composition may contain sugar or be sugar-free. In the present specification, the term “sugar-free” refers to a beverage in which a content of a saccharide (a monosaccharide or a disaccharide not including a sugar alcohol) contained in 100 mL of the composition is less than 0.5 g (see, Cabinet Office Ordinance No. 10 of 2015, Appendix 9 of Food Labeling Standards).

As described above, in an aspect, the composition in the present invention refers to a composition containing an extract obtained by processing and extracting a Theaceae plant by a known method, an infused liquor obtained by infusing the Theaceae plant in a liquid containing an alcohol, and a distilled liquor obtained by bringing the camellia plant into contact with a liquid containing an alcohol and distilling the resultant liquid. In one aspect, linalool, geraniol, and/or cis-3-hexen-1-ol contained in the composition of the present invention may be derived from the Theaceae plant.

In one aspect, the alcoholic beverage of the present invention may contain an extract obtained by, using a known method, processing and extracting a leaf of Camellia sinensis (also referred to as a “tea leaf” in the present specification) which is an evergreen belonging to Theaceae Camellia. The alcoholic beverage may also include an infused liquor obtained by infusing the leaf of Camellia sinensis in a liquid containing an alcohol and a distilled liquor obtained by bringing the leaf of Camellia sinensis in contact with a liquid containing an alcohol and distilling the resultant liquid. In one aspect, linalool, geraniol, and/or cis-3-hexen-1-ol contained in the alcoholic beverage of the present invention may be derived from Camellia sinensis.

The tea is classified into types of tea obtained by a processing method of tea leaves, particularly a difference in a degree of fermentation, and quality of tea extraction liquid from the tea varies also depending on the types of tea. For example, green tea is non-fermented tea in which picked tea leaves are heat-treated to lose enzyme activity, and thus, oxidation of components is prevented and green color is maintained. Oolong tea is obtained by slightly stimulating the picked tea leaves while wilting the tea leaves to oxidize a part of tea leaf components, and “pot-roasting” the resultant, and the oolong tea has an intermediate property between green tea and black tea, and is called semi-fermented tea. Black tea is obtained by wilting the picked tea leaves and thoroughly kneading the tea leaves and promoting oxidation of the tea leaf components by an oxidizing enzyme in the tea leaves to perform complete fermentation. In addition, there is also post-fermented tea in which the tea leaves are deposited for a long time to be subjected to a microbial action, and the components are sufficiently changed. Thus, in one aspect, linalool, geraniol, and/or cis-3-hexen-1-ol included in the composition of the present invention may be derived from the green tea, the oolong tea, the black tea, or the post-fermented tea.

In an aspect, the composition of the present invention contains a green tea-derived ingredient.

In one aspect, the composition of the present invention is the beverage having a fresh flavor of tea. A method for imparting the fresh flavor of tea is not particularly limited, and for example, the flavor can be imparted by blending a tea extract, or can be imparted by adding a component contributing to the flavor of tea. In the case of using the tea extract, the type and the processing method of the tea leaves as a raw material are not particularly limited, and for example, an aqueous extraction liquid containing a water-soluble solid content obtained by extracting the tea with water (hot water) can be used. As an addition mode, the tea extraction liquid as it is may be added to the alcoholic beverage, or a product obtained by concentrating, drying, and pulverizing the tea extraction liquid may be added to the alcoholic beverage. A liquid obtained by infusing, in the alcohol, the tea extraction liquid or the product obtained by concentrating, drying, and pulverizing the tea extraction liquid may be added, and further, it is more preferable to add a product concentrated by distilling the liquid.

In one aspect, the composition of the present invention is the beverage containing green tea distilled liquor. The green tea distilled liquor can be obtained, for example, by infusing the above-described green tea in an aqueous ethanol solution and distilling the resultant solution.

The composition of the present invention contains tannin in one aspect. Here, in the present specification, the term “tannin” is a name given to a plant component having an action of tanning hides, and examples thereof include “catechins”. In addition, in the present specification, the term “catechins” is a generic term for both non-gallate forms such as catechin, gallocatechin, epicatechin, and epigallocatechin, and gallate forms such as catechin gallate, gallocatechin gallate, epicatechin gallate, and epigallocatechin gallate, and in the present invention, at least one of the above eight kinds of the catechins may be contained.

In the composition of the present invention, the upper limit value of the content of tannin per 1.0 v/v % alcohol by volume is preferably 200 ppm, 180 ppm, 160 ppm, 140 ppm, 120 ppm, 110 ppm, and more preferably 100 ppm. In the composition of the present invention, the lower limit value of the content of tannin per 1.0 v/v % alcohol by volume is not particularly limited, and may be any of 0.01 ppm, 0.02 ppm, 0.03 ppm, 0.04 ppm, 0.05 ppm, 0.06 ppm, 0.07 ppm, 0.08 ppm, 0.09 ppm, and 0.10 ppm, or more, or may be 0.

In the composition of the present invention, the upper limit value of the content of catechins per 1.0 v/v % alcohol by volume is preferably 200 ppm, 180 ppm, 160 ppm, 140 ppm, 120 ppm, 110 ppm, and more preferably 100 ppm. In the composition of the present invention, the lower limit value of the content of catechins per 1.0 v/v % alcohol by volume is not particularly limited, and may be any of 0.01 ppm, 0.02 ppm, 0.03 ppm, 0.04 ppm, 0.05 ppm, 0.06 ppm, 0.07 ppm, 0.08 ppm, 0.09 ppm, and 0.10 ppm, or more, or may be 0.

In one aspect, in the composition of the present invention, a total amount of an extract content is 50.0 g/100 ml or less, preferably 40.0 g/100 ml, more preferably 30.0 g/100 ml. Here, the term “extract content” is a nonvolatile component defined by the Liquor Tax Law in Japan, and is defined to refer to the weight in grams of the nonvolatile component contained in 100 cubic centimeters of original volume at a temperature of 15° C. The content of the extract content in the beverage can be measured using the Official Analysis Method of the National Tax Agency in Japan. In the present specification, the content of the extract content is indicated as a weight (unit: g/100 ml) in 100 ml of the alcoholic beverage.

The composition of the present invention is typically a beverage containing no carbon dioxide gas, and may be a carbonated beverage by adding carbon dioxide gas as necessary. The carbon dioxide gas may be generated by fermentation or artificially injected.

The composition of the present invention is a beverage in one aspect, and is a packaged beverage in one aspect. The packaged beverage is advantageous because it can be stably stored for a long period of time. A container of the packaged beverage is not particularly limited, and any commonly used container such as a metal container, a resin container, a paper container, or a glass container can be used. Specific examples of the container include metal containers such as aluminum cans and steel cans, resin containers such as PET bottles, paper containers such as paper cartons, and glass containers such as glass bottles.

In the composition of the present invention, an additive such as a saccharide, an acid, a flavoring agent, a vitamin, a pigment, an antioxidant, an acidulant, an emulsifier, a preservative, a seasoning, an extract, a pH adjuster, and a quality stabilizer can be blended as long as the effects of the present invention are not hindered.

### 2. Method for Producing Composition and Method for Reducing Bitterness of Alcohol in Alcohol-Containing Composition

In one aspect, the present invention is a method for producing a composition, the method including: (i) blending linalool and/or geraniol; (ii) blending cis-3-hexen-1-ol; and (iii) blending alcohol. In one aspect, the present invention provides a method for reducing bitterness of alcohol in an alcohol-containing composition, the method including: (i) blending linalool and/or geraniol; (ii) blending cis-3-hexen-1-ol; and (iii) blending alcohol. The ranges of the contents of linalool, geraniol, and cis-3-hexen-1-ol in the composition, the range of the content per 1.0 v/v % alcohol by volume, the range of the alcohol by volume, the range of the degree of sweetness, the ranges of the contents of tannin, catechin, and the extract content, the aspect of the container, and the like are as described in the section of “1. Composition” as described above.

### EXAMPLES

The present invention will be described in more detail with reference to the following Examples, but the present invention is not limited to the specific aspects described in the following Examples. In addition, unless otherwise specified in the present specification, and the numerical ranges are described as including endpoints.

### Example 1: Effect of Contents of Cis-3-Hexen-1-Ol, Linalool, and Geraniol on Sensation of Irritation of Alcohol and Tea-Like Taste

### 1. Method for Preparing Sample Beverage

A raw material alcohol (59% neutral spirits) was diluted to 25 v/v % alcohol by volume, and a certain amount of sucrose was added to yield Sample No. 1. Sample No. 2 and Sample No. 3 were prepared by reducing the added amount of sucrose in Sample No. 1 and thus lowering each of the degrees of sweetness. Sample No. 4 was prepared by adding a flavoring agent to Sample No. 3 so that cis-3-hexen-1-ol was contained in an amount of 2 ppb and linalool was contained in an amount of 8 ppb. In each of Samples Nos. 5 to 9, a green tea extract was blended in addition to the flavoring agent, and the contents of cis-3-hexen-1-ol and linalool were adjusted. In each of Sample No. 10 and Sample No. 11, green tea distilled liquor was blended in addition to the flavoring agent and the green tea extract, and the contents of cis-3-hexen-1-ol and linalool were adjusted. The green tea extracts in Samples Nos. 5 to 12 were blended in the same amounts. For the green tea distilled liquor, the blending amount of the green tea distilled liquor in Sample No. 11 was twice as much as the blending amount of that in Sample No. 10. In Sample No. 12, a concentration of catechin was adjusted by adding catechin to Sample No. 11. Samples Nos. 1 to 12 had 25 v/v % alcohol by volume, and in a sensory evaluation described later, the samples diluted with water to 5.0 v/v % were evaluated. As the green tea extract, a tea leaf extraction liquid was used, and as the green tea distilled liquor, a liquor obtained by infusing tea leaves or tea leaf extraction liquid in an alcohol and then distilling the resultant liquid, was used. The concentration of each component in a sample beverage was calculated based on the concentration of each component (linalool, cis-3-hexen-1-ol, and catechin) in the flavoring agent, the green tea distilled liquor, and the green tea extract measured by entrusting to Japan Food Research Laboratories as an external analysis organization.

Also, a raw material alcohol (59% neutral spirits) was diluted to 25 v/v % alcohol by volume, and a certain amount of sucrose was added to yield Sample No. 13. Sample No. 14 was adjusted by reducing the added amount of sucrose in Sample No. 13 and thus lowering the degree of sweetness. Sample No. 15 was prepared by adding a flavoring agent to Sample No. 14 so that cis-3-hexen-1-ol was contained in an amount of 4 ppb and geraniol was contained in an amount of 12 ppb. In Samples Nos. 16 to 20, a green tea extract was blended in addition to the flavoring agent, and the contents of cis-3-hexen-1-ol and geraniol were adjusted. In Sample No. 21, green tea distilled liquor was blended in addition to the flavoring agent and the green tea extract, and the contents of cis-3-hexen-1-ol and linalool were adjusted. The green tea extracts in Samples Nos. 16 to 21 were blended in the same amounts. Samples Nos. 13 to 21 had 25 v/v % alcohol by volume, and in the sensory evaluation described later, the samples diluted with water to 5.0 v/v % were evaluated. As the green tea extract, a tea leaf extraction liquid was used, and as the green tea distilled liquor, a liquor obtained by infusing tea leaves or tea leaf extraction liquid in an alcohol and then distilling the resultant liquid, was used. The concentration of each component in the sample beverage was calculated based on the concentration of each component (geraniol, cis-3-hexen-1-ol, and catechin) in the flavoring agent, the green tea distilled liquor, and the green tea extract measured by entrusting to Japan Food Research Laboratories as an external analysis organization.

The results are listed in Tables 2 and 3.

### 2. Sensory Evaluation

Each sample beverage prepared in the above 1 was diluted with water to 5 v/v % alcohol by volume, and each of the diluted beverages was evaluated by a plurality of evaluators on a 5-point scale (from 1 to 5 points) from the viewpoints of “sensation of irritation of alcohol” and “tea-like taste”, and an average value of the scales was determined. The criteria for each stage are as follows. The results are listed in Table 1. With respect to the “sensation of irritation of alcohol”, the beverage having the average value of less than 4.0 was determined to have reduced sensation of irritation of alcohol. For the “tea-like taste”, the beverage having the average value of 2.0 or more was determined to be acceptable.

### <Evaluation Criteria of Sensation of Irritation of Alcohol>

5 points: sensation of irritation of alcohol is strong
4 points: sensation of irritation of alcohol is slightly strong
3 points: sensation of irritation of alcohol is slightly weak
2 points: sensation of irritation of alcohol is weak
1 point: almost no sensation of irritation of alcohol

### <Evaluation Criteria for Tea-Like Taste>

5 points: tea-like taste is strongly felt
4 points: tea-like taste is slightly strongly felt
3 points: tea-like taste is felt
2 points: tea-like taste is slightly felt
1 point: tea-like taste is not felt at all

TABLE 2

| | No. 1 | No. 2 | No. 3 | No. 4 | No. 5 | No. 6 |
|---|---|---|---|---|---|---|
| Cis-3-hexen-1-ol (ppb) | 0 | 0 | 0 | 2 | 45 | 46 |
| Linalool (ppm) | 0 | 0 | 0 | 8 | 32 | 35 |
| Alcohol by volume (v/v %) | 25 | 25 | 25 | 25 | 25 | 25 |
| Catechin (ppm) | 0 | 0 | 0 | 0 | 100 | 100 |
| Degree of sweetness | 15 | 5 | 2 | 2 | 2 | 2 |
| Alcohol by volume (v/v %) at the time of drinking | 5 | 5 | 5 | 5 | 5 | 5 |
| Cis-3-hexen-1-ol per 1 v/v % of alcohol (ppb) | 0 | 0 | 0 | 0.1 | 1.8 | 1.9 |
| Linalool per 1 v/v % of alcohol (ppb) | 0 | 0 | 0 | 0.3 | 1.3 | 1.4 |
| Catechin per 1 v/v % of alcohol (ppb) | 0 | 0 | 0 | 0 | 4 | 4 |
| Degree of sweetness per 1 v/v % of alcohol | 0.6 | 0.2 | 0.08 | 0.08 | 0.08 | 0.08 |
| Sensation of irritation of alcohol | 2.7 | 3.6 | 4.3 | 3.7 | 3.5 | 3.2 |
| Tea-like taste | 1.0 | 1.0 | 1.0 | 2.0 | 3.3 | 3.5 |

| | No. 7 | No. 8 | No. 9 | No. 10 | No. 11 | No. 12 |
|---|---|---|---|---|---|---|
| Cis-3-hexen-1-ol (ppb) | 48 | 50 | 51 | 66 | 85 | 85 |
| Linalool (ppm) | 39 | 47 | 50 | 44 | 51 | 51 |
| Alcohol by volume (v/v %) | 25 | 25 | 25 | 25 | 25 | 25 |
| Catechin (ppm) | 100 | 100 | 100 | 100 | 100 | 130 |
| Degree of sweetness | 2 | 2 | 2 | 2 | 2 | 2 |
| Alcohol by volume (v/v %) at the time of drinking | 5 | 5 | 5 | 5 | 5 | 5 |
| Cis-3-hexen-1-ol per 1 v/v % of alcohol (ppb) | 1.9 | 2.0 | 2.0 | 2.6 | 3.4 | 3.4 |
| Linalool per 1 v/v % of alcohol (ppb) | 1.6 | 1.9 | 2.0 | 1.7 | 2.0 | 2.0 |
| Catechin per 1 v/v % of alcohol (ppb) | 4 | 4 | 4 | 4 | 4 | 5.2 |
| Degree of sweetness per 1 v/v % of alcohol | 0.08 | 0.08 | 0.08 | 0.08 | 0.08 | 0.08 |
| Sensation of irritation of alcohol | 2.8 | 2.3 | 1.8 | 2.1 | 1.7 | 2.1 |
| Tea-like taste | 3.7 | 3.8 | 3.9 | 4.2 | 4.3 | 4.8 |

TABLE 3

| | No13 | No14 | No15 | No16 | No17 | No18 | No19 | No20 | No21 |
|---|---|---|---|---|---|---|---|---|---|
| Cis-3-hexen-1-ol (ppb) | 0 | 0 | 4 | 47 | 88 | 223 | 343 | 643 | 662 |
| Geraniol (ppb) | 0 | 0 | 12 | 36 | 174 | 623 | 1023 | 2022 | 2022 |
| Alcohol by volume (v/v %) | 25 | 25 | 25 | 25 | 25 | 25 | 25 | 25 | 25 |
| Catechin (ppm) | 0 | 0 | 0 | 100 | 100 | 100 | 100 | 100 | 100 |
| Degree of sweetness | 5 | 2 | 2 | 2 | 2 | 2 | 2 | 2 | 2 |
| Alcohol by volume (v/v %) at | 5 | 5 | 5 | 5 | 5 | 5 | 5 | 5 | 5 |
| the time of drinking | | | | | | | | | |
| Cis-3-hexen-1-ol per 1 v/v % of | 0 | 0 | 0.2 | 1.9 | 3.5 | 8.9 | 13.7 | 25.7 | 26.5 |
| alcohol (ppb) | | | | | | | | | |
| Geraniol per 1 v/v % of alcohol | 0 | 0 | 0.5 | 1.5 | 7.0 | 24.9 | 40.9 | 80.9 | 80.9 |
| (ppb) | | | | | | | | | |
| Catechin per 1 v/v % of alcohol | 0 | 0 | 0 | 4 | 4 | 4 | 4 | 4 | 4 |
| (ppm) | | | | | | | | | |
| Degree of sweetness per 1 v/v % | 0.2 | 0.08 | 0.08 | 0.08 | 0.08 | 0.08 | 0.08 | 0.08 | 0.08 |
| of alcohol | | | | | | | | | |
| Sensation of irritation of alcohol | 3.6 | 4.3 | 3.7 | 3.5 | 3.2 | 2.8 | 2.3 | 2.1 | 1.7 |
| Tea-like taste | 1.0 | 1.0 | 2.0 | 2.5 | 3.3 | 3.7 | 3.9 | 4.5 | 4.5 |

From the results in Table 2, in the beverage having a degree of sweetness of less than 0.2 per 1 v/v % alcohol by volume, the sensation of irritation of alcohol was felt (Sample No. 3). However, it was revealed that the sensation of irritation of such an alcohol was reduced by adjusting the concentrations of linalool and cis-3-hexen-1-ol (Samples Nos. 4 to 12). In addition, it was revealed that by adjusting the concentrations of linalool and cis-3-hexen-1-ol, the tea-like taste can also be imparted (Samples Nos. 4 to 12).

From the results in Table 3, it was revealed that a similar effect can be obtained even when the concentrations of geraniol and cis-3-hexen-1-ol are adjusted.

### Example 2: Effect of Addition of Cis-3-Hexen-1-Ol and Linalool or Addition of Cis-3-Hexen-1-Ol and Geraniol on Sensation of Irritation of Alcohol and Tea-Like Taste

A raw material alcohol (59% neutral spirits) was diluted to an 5.0 v/v % alcohol by volume, and cis-3-hexen-1-ol (Tokyo Chemical Industry Co., Ltd.), linalool (Tokyo Chemical Industry Co., Ltd.), and geraniol (Tokyo Chemical Industry Co., Ltd.) as commercially available standard products were blended so as to have the contents in Tables 4 to 5, and thus, Samples Nos. 22 to 35 were obtained.

Thereafter, a sensory evaluation was performed based on the same method and criteria as those in Example 1 with respect to “sensation of irritation of alcohol” and “tea-like taste”. The results are listed in Tables 4 and 5.

TABLE 4

| | No. 22 | No. 23 | No. 24 | No. 25 | No. 26 | No. 27 | No. 28 | No. 29 |
|---|---|---|---|---|---|---|---|---|
| Cis-3-hexen-1-ol (ppb) | 100 | 100 | 200 | 200 | 200 | 400 | 400 | 400 |
| Linalool (ppm) | 500 | 4000 | 500 | 2000 | 4000 | 2000 | 4000 | 5000 |
| Alcohol by volume (v/v %) | 5 | 5 | 5 | 5 | 5 | 5 | 5 | 5 |
| Degree of sweetness | 0 | 0 | 0 | 0 | 0 | 0 | 0 | 0 |
| Alcohol by volume (v/v %) at the | 5 | 5 | 5 | 5 | 5 | 5 | 5 | 5 |
| time of drinking | | | | | | | | |
| Cis-3-hexen-1-ol per 1 v/v % of | 20.0 | 20.0 | 40.0 | 40.0 | 40.0 | 80.0 | 80.0 | 80.0 |
| alcohol (ppb) | | | | | | | | |
| Linalool per 1 v/v % of alcohol (ppb) | 100.0 | 800.0 | 100.0 | 400.0 | 800.0 | 400.0 | 800.0 | 1000.0 |
| Degree of sweetness per 1 v/v % of | 0 | 0 | 0 | 0 | 0 | 0 | 0 | 0 |
| alcohol | | | | | | | | |
| Sensation of irritation of alcohol | 1.6 | 1.5 | 1.5 | 1.4 | 1.3 | 1.3 | 1.1 | 1.1 |
| Tea-like taste | 4.3 | 4.4 | 4.5 | 4.6 | 4.7 | 4.7 | 4.8 | 4.8 |

TABLE 5

| | No. | No. | No. | No. | No. | No. |
|---|---|---|---|---|---|---|
| | 30 | 31 | 32 | 33 | 34 | 35 |
| Cis-3-hexen-1-ol (ppb) | 100 | 200 | 200 | 400 | 400 | 400 |
| Geraniol (ppb) | 100 | 100 | 200 | 200 | 400 | 500 |
| Alcohol by volume (v/v %) | 5 | 5 | 5 | 5 | 5 | 5 |
| Degree of sweetness | 0 | 0 | 0 | 0 | 0 | 0 |
| Alcohol by volume (v/v %) | 5 | 5 | 5 | 5 | 5 | 5 |
| at the time of drinking | | | | | | |
| Cis-3-hexen-1-ol per 1 v/v % | 20.0 | 40.0 | 40.0 | 80.0 | 80.0 | 80.0 |
| of alcohol (ppb) | | | | | | |
| Geraniol per 1 v/v % of | 20.0 | 20.0 | 40.0 | 40.0 | 80.0 | 100.0 |
| alcohol (ppb) | | | | | | |
| Degree of sweetness per 1 | 0 | 0 | 0 | 0 | 0 | 0 |
| v/v % of alcohol | | | | | | |
| Sensation of irritation of | 2.2 | 1.7 | 1.6 | 1.4 | 1.3 | 1.1 |
| alcohol | | | | | | |
| Tea-like taste | 4.1 | 4.5 | 4.6 | 4.7 | 4.8 | 4.8 |

From the results in Tables 4 to 5, it was confirmed that, even when cis-3-hexen-1-ol and linalool, which were the commercially available standard products, or cis-3-hexen-1-ol and geraniol, which were the commercially available standard products, were blended instead of the flavoring agent, the green tea extract, and the green tea distilled liquor, the sensation of irritation of alcohol was reduced as in Example 1, and also, the tea-like taste could be imparted.

### Example 3: Effect of Addition of Green Tea Distilled Liquor on Sensation of Irritation of Alcohol and Tea-Like Taste

A raw material alcohol (59% neutral spirits) and the green tea distilled liquor used in Example 1 were added to adjust the alcohol by volume to 5.0 v/v %, and the amount of each component was adjusted with the commercially available standard products used in Example 2 to yield Sample 36. As described in Example 1, the concentration of each component in the green tea distilled liquor was analyzed by entrusting to Japan Food Research Laboratories. A proportion of the green tea distilled liquor in Sample 36 was about 10.8%.

Thereafter, a sensory evaluation was performed based on the same method and criteria as those in Example 1 with respect to “sensation of irritation of alcohol” and “tea-like taste”. The results are shown in Table 6.

TABLE 6

| | No. 36 |
|---|---|
| Cis-3-hexen-1-ol (ppb) | 400 |
| Linalool (ppm) | 4000 |
| Geraniol (ppb) | 400 |
| Alcohol by volume (v/v %) | 5 |
| Degree of sweetness | 0 |
| Alcohol by volume (v/v %) at the time of drinking | 5 |
| Cis-3-hexen-1-ol per 1 v/v % of alcohol (ppb) | 80.0 |
| Linalool per 1 v/v % of alcohol (ppb) | 800.0 |
| Geraniol per 1 v/v % of alcohol (ppb) | 80.0 |
| Degree of sweetness per 1 v/v % of alcohol | 0 |
| Sensation of irritation of alcohol | 1.2 |
| Tea-like taste | 4.8 |

From the results in Table 6, even when the green tea distilled liquor was used as a supply source of cis-3-hexen-1-ol, linalool, and geraniol, sensory evaluation results comparable to those of Sample 28 and Sample 34 of Example 2 were obtained, and it was confirmed that these three components contributed to reduction of the sensation of irritation of alcohol and imparting the tea-like taste.

1. A composition comprising:
linalool and/or geraniol;
cis-3-hexen-1-ol; and
an alcohol.

2. The composition according to claim 1, wherein a degree of sweetness per 1.0 v/v % alcohol by volume is 0.18 or less.

3. The composition according to claim 1, wherein a content of cis-3-hexen-1-ol per 1.0 v/v % alcohol by volume is 0.05 ppb or more.

4. The composition according to claim 1, wherein a content of linalool per 1.0 v/v % alcohol by volume is 0.02 ppb or more.

5. The composition according to claim 1, wherein a content of geraniol per 1.0 v/v % alcohol by volume is 0.05 ppb or more.

6. The composition according to claim 1, wherein the alcohol by volume is from 1 to 55 v/v %.

7. The composition according to claim 1, comprising linalool, geraniol and/or cis-3-hexen-1-ol derived from a Theaceae plant.

8. The composition according to claim 7, wherein the Theaceae plant is Camellia sinensis.

9. The composition according to claim 1, comprising linalool and cis-3-hexen-1-ol derived from green tea.

10. The composition according to claim 1, comprising green tea distilled liquor.

11. The composition according to claim 1, wherein the composition contains no carbon dioxide gas.

12. The composition according to claim 1, wherein a total amount of an extract content is 50.0 g/100 ml or less.

13. The composition according to claim 1, wherein the composition is a beverage.

14. The composition according to claim 13, wherein the composition is a packaged beverage.

15. The composition according to claim 13, wherein the composition is diluted and then consumed.

16. A method for producing a composition, the method comprising:
(i) blending linalool and/or geraniol;
(ii) blending cis-3-hexen-1-ol; and
(iii) blending an alcohol.

17. A method for reducing bitterness of alcohol in an alcohol-containing composition, the method comprising:
(i) blending linalool and/or geraniol;
(ii) blending cis-3-hexen-1-ol; and
(iii) blending an alcohol.
